(19) United States
(12) Patent Application Publication
(10) Pub. No.: US 2007/0073833 A1
(43) Pub. Date: Mar. 29, 2007

(54) Web page preview without browsing to web page

(75) Inventors: Shourya Roy, New Delhi (IN); Raghuram Krishnapuram, New Delhi (IN)

Correspondence Address: CLIFFORD B. PERRY, 132 N. EL CAMINO REAL, #347, ENCINITAS, CA, 92024-2801, US

(73) Assignee: International Business Machines Corporation, Armonk, NY (US)

(21) Appl. No.: 11/237,366

(22) Filed: Sep. 28, 2005

(51) Int. Cl. G06F 15/16

(52) U.S. Cl. 709/217

(57) ABSTRACT

Web pages are previewed without actually having to browse to those web pages. A method is performed in relation to a first web page being browsed by a user and that has a hyperlink to a second web page. The second web page is acquired, and a site-specific preview, a user-specific preview, and a time-specific preview of the second web page are constructed. The site-specific preview is specific to a web site encompassing the second web page. The user-specific preview is specific to the user browsing the first web page. The time-specific preview is nominally specific to a time at which the user previews the second web page. These three previews are combined into an overall preview. In response to the user performing an action in relation to the hyperlink on the first web page, the overall preview of the second web page is displayed without browsing to that page.

### FIELD OF THE INVENTION

The present invention relates generally to previewing a web page without browsing to that web page, and more particularly to such a web page preview that include a site-specific preview, a user-specific preview, and a time-specific preview of the web page.

### BACKGROUND OF THE INVENTION

The World-Wide Web (WWW), or “the web,” can be considered as a collection of displayable files, referred to as web pages, interconnected to one another over a network, specifically the Internet. A given web page may link to one or more other web pages. The linking is accomplished via a hyperlink. A hyperlink specifies the name and location of the linked to web page. A user typically browses web pages using a web-browsing program. A currently browsed to web page is displayed on the client computing device of the user. Hyperlinks to other web pages are typically denoted within the web page currently being displayed via underlining. By selecting a hyperlink, the web page to which the hyperlink points is loaded, or acquired, and displayed.

In general, there are three different types of hyperlinks that exist on the web: structural links, associative links, and referential links. The information contained within a portion of the web, such as a given web site hosting or storing a number of related web pages, may be organized in a suitable fashion represented by the structural links. The structural links may be grouped together to create different types of structures of the web pages on the web.

An associative link is an instantiation of a semantic relationship between different information elements. That is, an associative link is completely independent of the specific structure of the information contained on a given set of web pages on the web, and instead is based on the meaning of the different information elements, and associates two related concepts. A referential link is related to an associative link. Rather than representing an association between two related concepts, a referential link provides a link between an item of information and an elaboration or explanation of that information.

The process of web browsing, or web surfing, is moving from place to place on the web by selecting hyperlinks on currently displayed web pages. Thus, the term web browsing or web surfing can be considered an undirected process in which a user jumps from web page to web page as he or she desires, instead of, for instance, specifically searching for a desired piece of information. Many hyperlinks are very short, and contain little description of the web pages to which they point. For instance, some hyperlinks are simply specified as “more,” or “click here.” Therefore, it is not always possible, even considering the context of a hyperlink, to glean what information is present in the web page to which a hyperlink points.

A limited solution to this problem is the utilization of link previews. For instance, web pages to which hyperlinks of a currently browsed web page point may be pre-fetched, or acquired, while the user is reviewing the information on the web page. When a user causes the mouse pointer to hover over a hyperlink on the web page, by causing the mouse pointer to move over the hyperlink and stay there for a predetermined length of time, a preview of the web page to which the hyperlink points may be displayed, such as in a small box near the hyperlink referred to as a tool tip. In this way, the user is able to glean what information is present in a web page to which a hyperlink points without having to actually browse to that web page.

However, current link preview technology is typically rule-based, and otherwise generates web page previews in the same way for all types of web pages to which hyperlinks point. Therefore, the information contained in a given web page preview may not be particularly relevant for a given type of web page, and/or may not be what a given user is looking for when viewing the preview. However, in at least some instances link previews may not be particularly helpful to the browsing user. For this and other reasons, there is a need for the present invention.

### SUMMARY OF THE INVENTION

The present invention relates to previewing web pages without actually browsing to those web pages. A method of the invention is performed in relation to a first web page being browsed by a user and that has a hyperlink to a second web page. The second web page is acquired, and a site-specific preview, a user-specific preview, and a time-specific preview of the second web page are constructed. The site-specific preview is specific to a web site encompassing the second web page. The user-specific preview is specific to the user browsing the first web page. The time-specific preview is nominally specific to a time at which the user previews the second web page. These three previews are combined into an overall preview of the second web page. In response to the user performing an action in relation to the hyperlink on the first web page, the overall preview of the second web page is displayed without actually browsing to the second web page.

A computing device of the invention includes a communication mechanism, a browsing mechanism, and a previewing mechanism. The communication mechanism communicatively couples the computing device with a network to which other computing devices are communicatively coupled. The browsing mechanism is to retrieve web pages from the other computing devices and to display the web pages to a user of the computing device. The previewing mechanism is to display an overall preview of a second web page in response to the user performing an action in relation to a hyperlink to the second web page on a first web page being browsed by the user via the browsing mechanism. The overall preview of the second web pages includes a combination of the site-specific preview, the user-specific preview, and the time-specific preview of the second web page that have been described.

An article of manufacture of the invention includes a computer-readable medium and means in the medium. The computer-readable medium may be a recordable data storage medium, a modulated carrier signal, or another type of computer-readable medium. The means is for displaying an overall preview of a second web page in response to a user performing an action in relation to a hyperlink to the second web page on a first web page being browsed by the user. The overall preview of the second web pages includes a combination of the site-specific preview, the user-specific preview, and the time-specific preview of the second web page that have been described.

Embodiments of the invention provide for advantages over the prior art. In particular, the link previewing capability of embodiments of the invention provides more relevant information regarding a web page pointed to by a hyperlink, as compared to the link previewing technology within the prior art. For instance, the site-specific preview provides a preview of the web page that is related to the type of the web site that encompasses the web page in question. The user-specific preview provides a preview of the web page that is relevant to the user who is previewing the web page. The time-specific preview ensures that the preview is nominally up to date. By having these three types of previews combined into an overall web page preview that is displayed when a user causes a mouse pointer to hover over a hyperlink to the web page, or otherwise performs an action in relation to the hyperlink, the user is more likely to be able to glean the desired information on the web page, without actually having to browse to that web page.

Still other advantages, embodiments, and aspects of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flowchart of a method for generating a preview of a web page, according to an embodiment of the invention, and is suggested for printing on the first page of the patent.

FIG. 2 is a diagram of a representative system, according to an embodiment of the invention.

FIG. 3 is a flowchart of a method for generating a site-specific preview of a web page, according to an embodiment of the invention.

FIG. 4 is a flowchart of a method for generating a user-specific preview of a web page, according to an embodiment of the invention.

FIG. 5 is a flowchart of a method for generating a time-specific preview of a web page, according to an embodiment of the invention.

FIG. 6 is a diagram depicting the display of a preview of a web page in response to the user having performed an action in relation to a hyperlink to the web page on another web page, according to an embodiment of the invention.

FIG. 7 is a diagram of a representative computing device, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

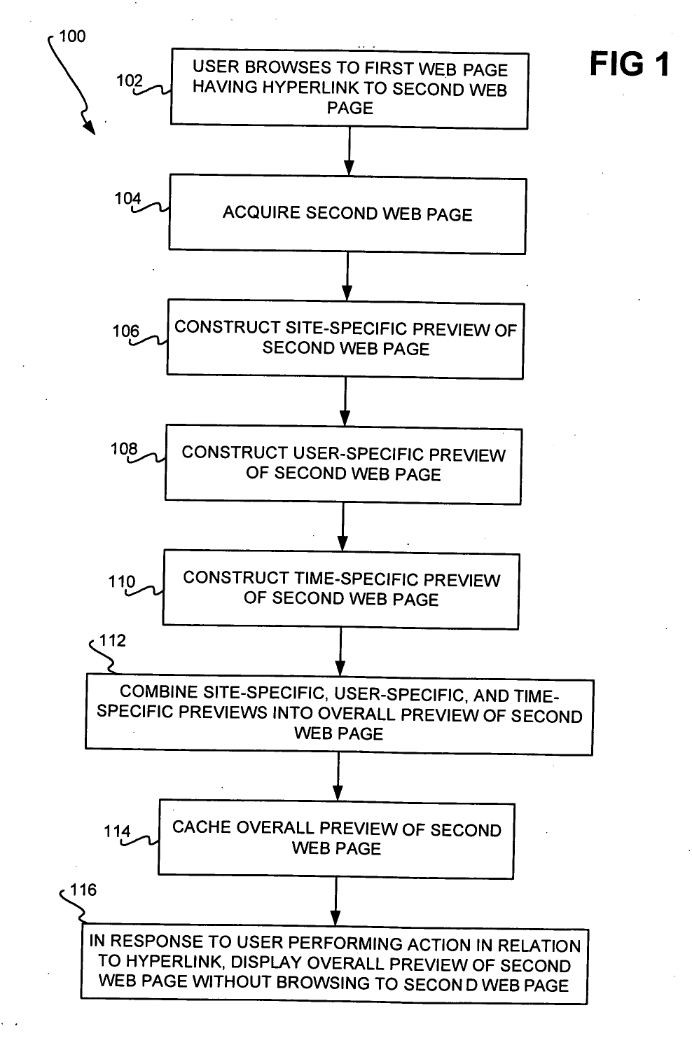

FIG. 1 shows a method 100, according to an embodiment of the invention. A user browses to a first web page that has a hyperlink to a second web page (102). Web pages are files that are stored on different computing devices, and are typically organized as sets of web pages on different web sites, which are collections of web pages. The computing devices are interconnected to one another via being communicatively connected to the same network, such as the Internet. The collection of all the web pages that are retrievable over the Internet is referred to as the World-Wide Web (WWW), or “the web.”

Web pages reference one another via hyperlinks. A hyperlink is a specification of the name and location of a linked to web page on the Internet. Thus, the first web page having a hyperlink to the second web page means that the first web page has a specification of the name and location of the linked to web page. For example, a hyperlink may be “http://www.example.com/webpage.html,” where “http://” specifies the hypertext transport protocol, “www.example.com” specifies the web site in which the linked to web page is located, and “webpage.html” specifies the name of this web page.

It is noted that embodiments of the invention for illustrative and descriptive clarity and convenience are described and depicted in relation to a first web page having a hyperlink to a second web page. However, embodiments of the invention are more generally applicable to a large number of web pages interconnected to one another via hyperlinks. For instance, a first web page may have hyperlinks to a number of additional web pages, and these additional web pages may have hyperlinks to one another and/or different web pages, including the first web page itself.

The terminology “browsing of the first web page” specifically encompasses two actions. First, the web page is acquired, or loaded, by the client computing device in relation to which the method 100 is being performed. That is, the file representing the web page is transferred by the client computing device from the server computing device that is hosting the web site encompassing the web page, and thus storing this file, over the Internet or other network. Second, the web page is displayed at the client computing device. That is, the contents of the file representing the web page are appropriately parsed and displayed on a display device connected to the client computing device. Both of these actions are typically performed by a web-browsing computer program running on the client computing device.

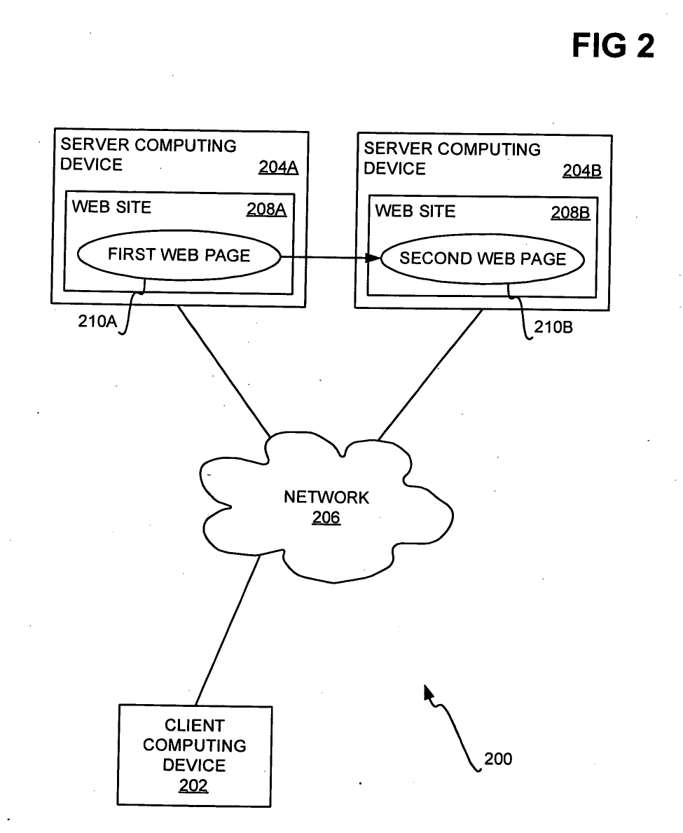

FIG. 2 shows a representative system 200 that is provided as one example of the type of system topology in relation to which the method 100 of FIG. 1 can be performed, according to an embodiment of the invention. The system 200 includes a client computing device 202, two server computing devices 204A and 204B and that are collectively referred to as the server computing devices 204, and a network 206 that can include the Internet. The client computing device 202 and the server computing devices 204 are communicatively connected to one another via the network 206. As can be appreciated by those of ordinary skill within the art, the system 200 can and typically will include more than one client computing device and more than two server computing devices.

The server computing device 204A hosts a web site 208A that includes or encompasses a first web page 210A. The server computing device 204B hosts a web site 208B that includes or encompasses a second web page 210B. The first web page 210A has a hyperlink pointing to the second web page 210B, as indicated by the arrow 212. Other hyperlinks may exist on the first web page 210A that point to web pages on the web site 208A, the web site 208B, or web sites hosted by the server computing devices 204 or other server computing devices.

Thus, when a user at the client computing device 202 browses to the first web page 210A, the client computing device 202 acquires or loads the first web page 210A from the server computing device 204A over the network 206, and displays this web page 210A to the user. If the user selects the hyperlink represented by the arrow 212, the client computing device 202 acquires or loads the second web page 210B from the server computing device 204B over the network 206, and displays this web page 210B to the user. This web-browsing process can continue as desired by the user, where the user selects different hyperlinks on web pages to browse to the web pages pointed to by the hyperlinks selected.

It is noted that the distinction between a client computing device and a server computing device is provided in FIG. 2 for illustrative and descriptive convenience and clarity only, and this distinction may not represent a real distinction between different types of computing devices. The client computing device 202 is a computing device at which web browsing is accomplished. The server computing devices 204 are computing devices that host the web sites 208 and that provide the web pages 210 thereof to the client computing device 202 as requested. However, more generally, a client computing device may also be a server computing device and vice-versa. That is, a client computing device may also host a web site, and a server computing device may also allow for web browsing to be performed thereat.

Referring back to FIG. 1, in response to the user browsing to the first web page having a hyperlink to a second web page, the method 100 acquires the second web page (104). Acquiring the second web page means that the client computing device at which the first web page is being browsed loads, pre-fetches, or receives the file representing the second web page from the server computing device hosting a web site that encompasses the second web page. The acquisition performed in part 104 of the method 100 is not browsing, however. That is, while the file representing the second web page is acquired, it is not displayed to the user. Thus, one of the two parts of what browsing entails is not performed in part 104 of the method 100.

Next, a site-specific preview of the second web page is constructed (106). The site-specific preview is a summary of the second web page that is specific to the web site which encompasses the second web page. The site-specific preview is specific to the web site that encompasses the second web page in that it is generated based on the type of the web site that encompasses the second web page, in one embodiment of the invention. For example, web sites may be categorized into different categories including, but not limited to: news web sites like www.cnn.com and www.msnbc.com, and portal web sites like www.msn.com and www.yahoo.com. Such categories may further include education web sites like those of universities and other educational institutions, documentation web sites that primarily serve as repositories of documents, and personal homepage web sites that are created by individual users. Such categories are not necessarily the result of topical categorization, but primarily are based on the functionalities and the nature of the organizations sponsoring the web sites.

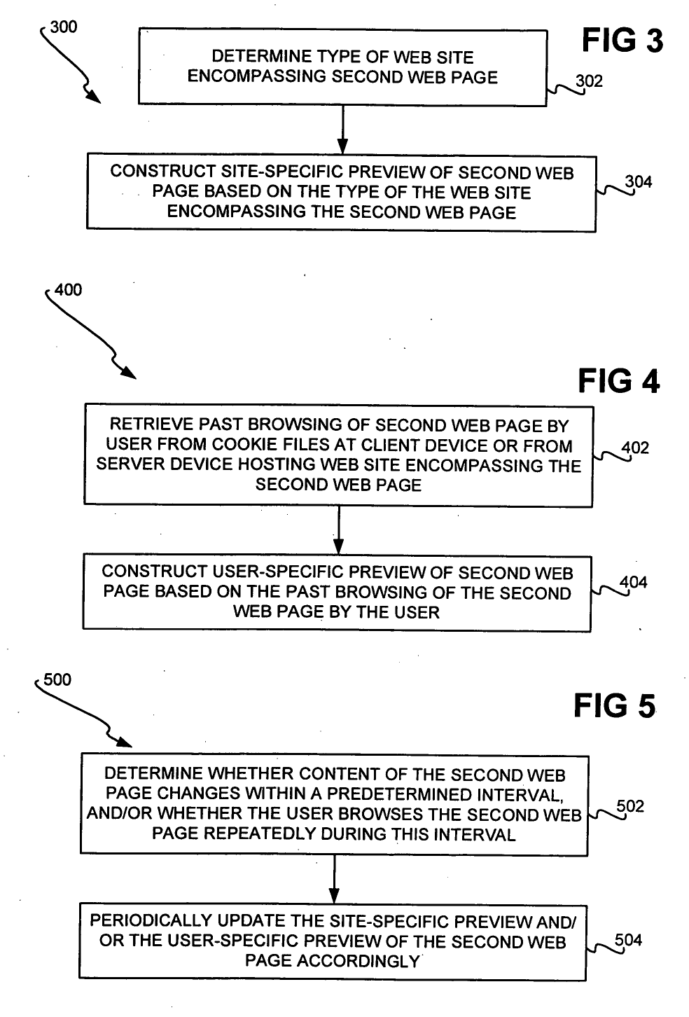

FIG. 3 shows a method 300 that may be employed to construct the site-specific preview of the second web page in part 106 of the method 100 of FIG. 1, according to an embodiment of the invention. First, the type of the web site encompassing the second web page is determined (302). Determining the type of the web site may in one embodiment entail analyzing the content of the web site to categorize the web site as one of a number of different web site types, based on aspects of the web site as compared to predefined attributes of different web site types. For example, the likelihood that the web site is of each different type may be scored, and the highest score that the web site has for a given type is used to conclude that the web site is of this given type. Determining the type of the web site may in another embodiment entail simply having predefined lists of web sites as being of certain web site types, such that where the web site is present on a given list, it is of the type specified for that list.

Next, the site-specific preview of the second web page is constructed based on the type of the web site encompassing the second web page, as has been determined (304). Different types of web sites may result in different types of site-specific previews of the second web page being constructed. For example, for news-related web sites, a useful preview may be the most recent headlines to be collected and summarized as the site-specific preview of the second web page. As another example, for education-related web sites, a useful preview of a web page regarding the faculty of an educational institution may be the list of the faculty members, whereas a useful preview of a web page regarding a graduate school may be the headings within the web page, such as courses, publications, research interests, and so on. Such site-specific previews may thus be constructed differently for different types of web sites.

Referring back to FIG. 1, a user-specific preview of the second web page is also constructed (108). The user-specific preview is a summary of the second web page that is specific to the user that is browsing the first web page in part 102 of the method 100, and that may have previously browsed the second web page. Users may view different web pages for different types of information. Thus, the second web page may be important to one user for one reason, and may be important to another user for another reason, such that a given portion of the information contained in the second web page may be important for the former user and unimportant for the latter user. Some users may frequently browse to the second web page, whereas other users may only browse to the second web page infrequently. Therefore, the user-specific preview is particular to the characteristics of the second web page in relation to a given user.

FIG. 4 shows a method 400 that may be employed to construct the user-specific preview of the second web page in part 108 of the method 100 of FIG. 1, according to an embodiment of the invention. First, the past browsing history of the second web page by the user is retrieved (402). In one embodiment, the past browsing history may be retrieved by retrieving one or more cookie files at the client computing device at which the user is browsing the first web page, and at which the user has in the past browsed the second web page. The cookie files are small files generated by the server computing device hosting the web site encompassing the second web page, but which are stored at the client computing device. Cookie files typically store information like unique user identifiers (ID's) of the user, the last visit on the web page by the user, the browsing path followed by the user when visiting the web site, and so on. The cookie files pertaining to the past browsing of the second web page by the user are thus of particular interest.

In another embodiment, the past browsing history may be retrieved instead from the server computing device hosting the web site encompassing the second web page. For instance, the server computing device typically identifies users of its web site via identifiers (ID's) of the users, which are usually the Internet Protocol (IP) addresses of the client computing devices used by the users to browse the web site and that identifies the client computing devices on the network in question, such as the Internet. Based on this information, the server computing device may store the past browsing history of the user in relation to which the method 100 of FIG. 1 is being performed, and provide this information back to the client computing device of this user so that a user-specific preview of the second web page may be constructed.

The past browsing history thus includes the identities of one or more third web pages that the user has browsed to in the past starting from the second web page. For example, a user may have started on the second web page, and then browsed to a web page A, and from the web page A browsed to a web page B. The web pages A and B in this example are the third web pages that the past browsing history denotes the identities thereof. That is, the past browsing history denotes that the user, from the second web page, first browsed to the web page A, and then browsed to the web page B.

Therefore, regardless of how the past browsing history of the second web page by the user is obtained, a user-specific preview of the second web page is constructed based on this past browsing history (404). For instance, the cookie files may be reviewed to determine this past browsing history, or the data provided by the server computing device may be reviewed to determine this past browsing history, on which basis the user-specific preview of the second web page is constructed. The user-specific preview may thus contain information relevant to what the user has previously browsed to on the second web page.

For instance, if the second web page is the home page for an electronic commerce (“e-commerce”) web site, and if a user has in the past frequently browsed from this home page to a DVD web page, and then to a Genres web page, and finally to an Opera web page, then the user-specific preview of the second web page may actually include information present on the Opera web page, instead of just a general preview of the home page itself. That is, in this example, the user-specific preview of the second web page includes information or content present on other web pages that are indirectly or directly linked to the second web page (such as on the same web site), where the second web page ultimately links to these other web pages and where the user had previously browsed to these other web pages from the second web page.

As another example, the second web page may be the home page for a news web site. A user may in the past have browsed from this home page to a sports web page, then to a football web page, and finally to a scores web page. Therefore, the user-specific preview of the second web page may actually include the information present on the scores web page, instead of just a general preview of the home page of the news web site itself. In this example, too, the user-specific preview of the second web page includes information or content present on other web pages that are indirectly or directly linked to the same web page, where the second web page ultimately links to these other web pages and where the user had previously browsed to these other web pages from the second web page.

Referring back to FIG. 1, a time-specific preview of the second web page is further constructed (110). The time-specific preview may be considered as being nominally specific to the time at which the user ultimately previews the second web page, as will be described later in the detailed description in relation to part 116 of the method 100. That is, the content of the second web page may change over time. Desirably, the time-specific preview that is viewed by the user (i.e., displayed to the user) reflects the content of the second web page at this time, such that it is said that the preview is specific to the time at which the user previews the second web page. However, in actuality, the preview that is displayed to and viewed by the user may be slightly out-of-date, such that it is instead said that the preview is nominally specific to the time at which the user previews the second web page. This is because the preview is generated before the user performs an action to view the preview, instead of being generated when the action is performed, such that the second web page may change between when the preview is generated and when it is viewed by the user.

Whereas the site-specific preview and the user-specific preview of the second web page that have been described presume to some extent static web pages that do not change greatly in a given period of time, the time-specific preview takes into account that these previews may change greatly over a given time period. For example, a news web site may have different news items on its web pages being updated throughout the day. As another example, an e-commerce web site may offer different items, or differently price items, over time, such as over a period of days, weeks, and so on. The time-specific preview takes such changes to the second web page into account.

FIG. 5 shows a method 500 that may be employed to construct the time-specific preview of the second web page in part 110 of the method 100 of FIG. 1, according to an embodiment of the invention. First, the method 500 determines whether the content of the second web page has changed within a predetermined time interval, and/or whether the user has browsed the second web page repeatedly during this interval (502). The predetermined time interval may be measured in hours, minutes, days, or even months, and may itself be particular to the web site that encompasses the second web page.

Next, the method 500, in response to determining that the content of the second web page has changed, and/or that the user has browsed the second web page more than once during the interval in question, periodically updates the site-specific preview and/or the user-specific preview of the second web page (504). Thus, the time-specific preview of the second web is the updated version of the site-specific preview and/or the user-specific preview in one embodiment. The periodic updating is performed without the user having to reload the first web page.

For example, it may be determined that the content of the second web page changes within a given time interval. For instance, the content of the second web page may be acquired each time the given time interval elapses, and compared to the content of the second web page as previously acquired. If the content is different, then it can be concluded that the content of the second web page has changed. As another example, it may be determined that the user browses to the second web page repeatedly within a given time interval. Such information can be determined from the past browsing history of the user in relation to the second web page, for instance.

In response, the site-specific preview and/or the user-specific preview is periodically updated, as the time-specific preview of the second web page, without the user having to reload the first web page. Thus, while the user is viewing the first web page, the parts 104 and 106 and/or 108 are reperformed periodically. That is, the second web page is reacquired, and the site-specific preview and/or the user-specific preview regenerated, as the time-specific preview of the second web page. In one embodiment, then, the time-specific preview of the second web page is not a separate preview, but rather an indication or denotation that the site-specific preview and/or the user-specific preview has been updated to reflect the updated content of the second web page.

For example, a user may visit a news web site throughout the day to obtain the latest headlines. Therefore, when the user is browsing the first web page, where the first web page links to a second web page that is encompassed by the news web site, the preview of the second web page is updated periodically to reflect the changing content of the news web site. For instance, the latest headlines may periodically change, such that the time-specific preview of the second web page changes, without the user having to reload the first web page. That is, even when the user has not performed any further action at the client computing device after the first web page has been browsed to, the client computing device periodically updates the time-specific preview of the second web page, so that the preview of the second web page may change each time the user views the preview.

Referring back to FIG. 1, the site-specific, user-specific, and time-specific previews that have been generated are then combined into an overall preview of the second web page (112). For instance, in one embodiment, the three different specific previews are simply concatenated together to generate the overall preview of the second web page. In another embodiment, the site-specific preview and/or the user-specific preview are replaced with the time-specific preview within the overall preview of the second web page. This is particularly the case where the time-specific preview is an updated version of the site-specific preview or the user-specific preview.

The overall preview of the second web page can then in one embodiment be cached (114). Caching the overall preview of the second web page also for subsequent browsing of a web page having a hyperlink to the second web page to regenerate the overall preview of the second web page by simply retrieving it from the cache. When the overall preview of the second web page is cached, in other words, the second web page does not have to be reacquired, the site-specific, user-specific, and time-specific previews do not have to be reconstructed, and the overall preview does not have to recombined from these specific previews upon subsequent browsing to web pages including hyperlinks to the second web page.

Ultimately, the user performs an action in relation to the hyperlink displayed on the first web page to the second web page, such that in response the overall preview of the second web page is displayed without the user having to browse to the second web page (116). In one embodiment, the action performed by the user involves the user causing a mouse pointer to move over the hyperlink as displayed on a display device and stay there for at least a given length of time. The overall preview of the second web page may be displayed within a box located near the hyperlink as displayed on the display device, such as within a tool tip, as known within the art.

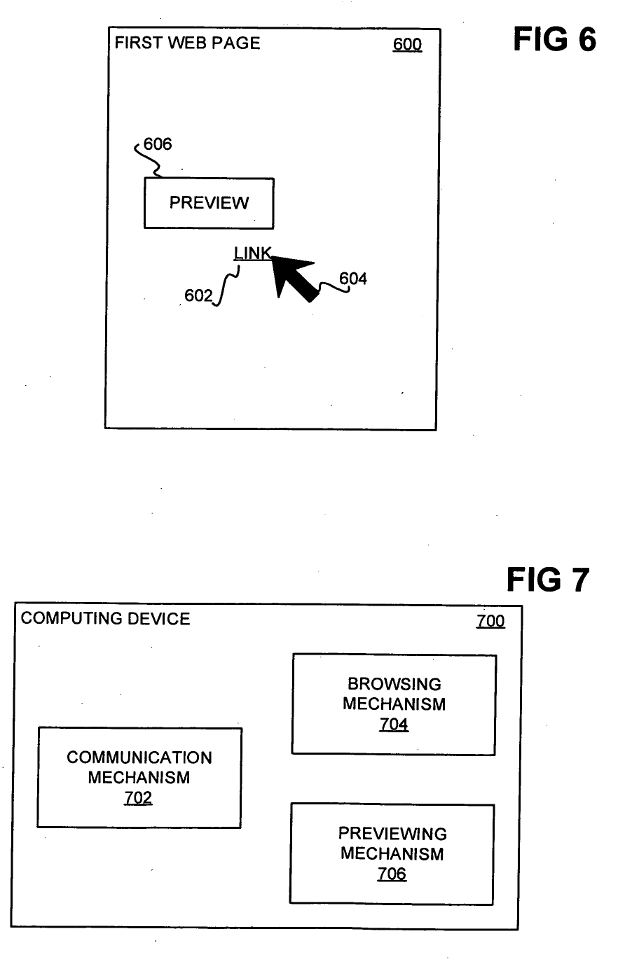

FIG. 6 shows an example of the display of the preview of the second web page in the part 116 of the method 100 of FIG. 1, according to an embodiment of the invention. A first web page 600 is being displayed that includes a hyperlink 602 to a second web page. A user has caused a mouse pointer 604 to hover over or near the hyperlink 602. In response, the preview 606 of the second web page is displayed within a box, or tool tip, near the hyperlink 602 to the second web page. Thus, viewing the preview 606 enables the user to discern some of the content of the second web page without actually browsing to the second web page. That is, the second web page is itself not displayed in its entirety.

FIG. 7 shows a representative computing device 700 that can function as the client computing device 202, according to an embodiment of the invention. The computing device 700 is depicted in FIG. 7 as including a communication mechanism 702, a browsing mechanism 704, and a previewing mechanism 706. As can be appreciated by those of ordinary skill within the art, the computing device 700 can and typically does include additional components, in addition to and/or in lieu of those depicted in FIG. 7. Each of the mechanisms 702, 704, and 706 may be implemented in hardware, software, or a combination of hardware and software.

The communication mechanism 702 communicatively connects the computing device 700 to a network to which other computing devices are communicatively connected. The network may be the Internet, for instance, and the communication mechanism 702 may be or include a wireless or a wired network adapter, a modem, or another type of communication mechanism. The browsing mechanism 704 is able to retrieve web pages from the other computing devices and display them to a user of the computing device 202. The browsing mechanism 704 may thus be or include a web browsing computer program or operating system component.

Finally, the previewing mechanism 706 is able to display an overall preview of a second web page in response to the user performing an action in relation to a hyperlink to the second web page on a first web page being browsed by the user, as has been described. The previewing mechanism 706 may be part of the browsing mechanism 704 and/or part of a web browsing computer program or operating system component. The previewing mechanism 706 may further be a plug-in software component that extends the functionality of such a web browsing computer program or operating system component, as known within the art.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

1. A method comprising:
for a first web page being browsed by a user, the first web page having a hyperlink to a second web page,
acquiring the second web page;
constructing a site-specific preview of the second web page that is specific to a web site encompassing the second web page;
constructing a user-specific preview of the second web page that is specific to the user browsing the first web page;
constructing a time-specific preview of the second web page that is nominally specific to a time at which the user previews the second web page;
combining the site-specific preview, the user-specific preview, and the time-specific preview into an overall preview of the second web page; and,
in response to the user performing an action in relation to the hyperlink on the first web page, displaying the overall preview of the second web page without browsing to the second web page.

2. The method of claim 1, further comprising the user initially browsing the first web page, such that the first web page is acquired by a client device over a network from a server device hosting a web site encompassing the first web page, and is displayed at the client device.

3. The method of claim 1, further comprising caching the overall preview of the second web page, such that subsequent browsing to a web page having a hyperlink to the second web page results in retrieving the overall preview of the second web page as cached, without having to acquire the second web page, without having to construct the site-specific preview, the user-specific preview, and the time-specific preview, and without having to combine the site-specific preview, the user-specific preview, and the time-specific preview into the overall preview of the second web page.

4. The method of claim 1, wherein constructing the site-specific preview of the second web page comprises:
determining a type of the web site encompassing the second web page; and,
constructing the site-specific preview of the second web page based on the type of the web site encompassing the second web page.

5. The method of claim 4, wherein determining the type of the web site encompassing the second web page comprises determining the type of the web site as one of a group of web site types comprising: a news web site, a portal web site, an education web site, a document web site, and a personal homepage web site.

6. The method of claim 1, wherein constructing the user-specific preview of the second web page comprises:
retrieving one or more cookie files at a client device at which the user is browsing the first web page, the cookie files pertaining to past browsing of the second web page by the user; and,
constructing the user-specific preview of the second web page based on the past browsing of the second web page by the user.

7. The method of claim 6, wherein constructing the user-specific preview of the second web page further comprises reviewing the cookie files to determine the past browsing of the second web page as one or more third web pages that the user has browsed starting from the second web page.

8. The method of claim 1, wherein constructing the user-specific preview of the second web page comprises:
retrieving past browsing of the second web page by the user from a server device hosting the web site encompassing the second web page, based on an identifier of the user; and,
constructing the user-specific preview of the second web page based on the past browsing of the second web page by the user.

9. The method of claim 8, wherein retrieving the past browsing of the second web page by the user comprises retrieving identities of one or more third web pages that the user has browsed starting from the second web page.

10. The method of claim 8, wherein the identifier of the user comprises an address of a client device at which the user is browsing the first web page and that identifies the client device.

11. The method of claim 1, wherein constructing the time-specific preview of the second web page comprises:
determining whether content of the second web page changes within a predetermined time interval; and,
in response to determining that the content of the second web page changes within the predetermined time interval, periodically updating at least one of the site-specific preview and the user-specific preview of the second web page, as the time-specific preview of the second web page, after the user has browsed to the first web page without the user having to reload the first web page.

12. The method of claim 1, wherein constructing the time-specific preview of the second web page comprises:
determining whether the user browses the second web page repeatedly within a predetermined time interval; and,
in response to determining that the user browses the second web page repeatedly within the predetermined time interval, periodically updating at least one of the site-specific preview and the user-specific preview of the second web page, as the time-specific preview of the second web page, after the user has browsed to the first web page without the user having to reload the first web page.

13. The method of claim 1, wherein combining the site-specific preview, the user-specific preview, and the time-specific preview into the overall preview of the second web page comprises concatenating the site-specific preview, the user-specific preview, and the time-specific preview together as the overall preview of the second web page.

14. The method of claim 1, wherein combining the site-specific preview, the user-specific preview, and the time-specific preview into the overall preview of the second web page comprises replacing at least one of the site-specific preview and the user-specific preview with the time-specific preview within the overall preview of the second web page where the time-specific preview is an updated version of the site-specific preview or the user-specific preview.

15. The method of claim 1, wherein the user performing the action in relation to the hyperlink comprises the user causing a pointer to move over the hyperlink as displayed on a display device for at least a predetermined length of time.

16. The method of claim 1, wherein displaying the overall preview of the second web page comprises displaying the overall preview of the second web page within a box.

17. A computing device comprising:
a communication mechanism communicatively coupling the computing device with a network to which other computing devices are communicatively coupled;
a browsing mechanism to retrieve web pages from the other computing devices and to display the web pages to a user of the computing device; and,
a previewing mechanism to display an overall preview of a second web page in response to the user performing an action in relation to a hyperlink to the second web page on a first web page being browsed by the user via the browsing mechanism,
wherein the overall preview of the second web page comprises a combination of a site-specific preview of the second web page that is specific to a web site encompassing the second web page, a user-specific preview of the second web page that is specific to the user browsing the first web page, and a time-specific preview of the second web page that is nominally specific to a time at which the user previews the second web page.

18. The computing device of claim 17, wherein:
the site-specific preview of the second web page is constructed by the previewing mechanism based on a type of the web site encompassing the second web page;
the user-specific preview of the second web page is constructed by the previewing mechanism based on past browsing of the second web page by the user; and,
the time-specific preview of the second web page is constructed by the previewing mechanism as a periodic update of at least one of the site-specific preview and the user-specific preview of the second web page.

19. An article of manufacture comprising:
a computer-readable medium; and,
computer code in the medium for displaying an overall preview of a second web page in response to a user performing an action in relation to a hyperlink to the second web page on a first web page being browsed by the user,
wherein the overall preview of the second web page comprises a combination of a site-specific preview of the second web page that is specific to a web site encompassing the second web page, a user-specific preview of the second web page that is specific to the user browsing the first web page, and a time-specific preview of the second web page that is nominally specific to a time at which the user previews the second web page.

20. The article of manufacture of claim 19, wherein:
the computer code is further for constructing the site-specific preview of the second web page based on a type of the web site encompassing the second web page;
the means is further for constructing the user-specific preview of the second web page based on past browsing of the second web page by the user; and,
the computer code is further for constructing the time-specific preview of the second web page as a periodic update of at least one of the site-specific preview and the user-specific preview of the second web page.
